(19) United States
(12) Patent Application Publication
(10) Pub. No.: US 2016/0208876 A1
(43) Pub. Date: Jul. 21, 2016

(54) CENTRIFUGAL PENDULUM STOP SPRING ELEMENT, CENTRIFUGAL PENDULUM DEVICE AND COMPONENT ARRANGEMENT

(71) Applicant: SCHAEFFIER TECHNOLOGIES AG & CO. KG, Herzogenaurach (DE)

(72) Inventor: Parviz Movlazada, Rastatt (DE)

(73) Assignee: Schaeffler Technologies AG & Co. KG, Herzogenaurach (DE)

(21) Appl. No.: 14/913,183

(22) PCT Filed: Sep. 2, 2014
(86) PCT No.: PCT/DE2014/200436

§ 371 Date: Feb. 19, 2016

(30) Foreign Application Priority Data
Sep. 4, 2013 (DE) 10 2013 217 610.4

(51) Int. Cl. F16F 1/10; F16D 3/12; F16F 15/14

(52) U.S. Cl. CPC F16F 1/10; F16F 15/1421; F16D 3/12; F16F 15/145; F16F 2238/024; F16F 2238/04

(57) ABSTRACT

A centrifugal pendulum stop spring element for a centrifugal pendulum device (1) is provided, in particular a trapezoidal centrifugal pendulum device, of a drive train of a motor vehicle, the stop spring element (30) having a plurality of material layers (31) in a radial direction (Ra) of the stop spring element, and the material layers being coupled to each other in such a manner that the stop spring element is resilient in the radial direction thereof. A centrifugal pendulum device, a pendulum weight carrier and/or a pendulum weight of the centrifugal pendulum device having a centrifugal pendulum stop spring element is also provided. A component arrangement for a drive train of a motor vehicle is provided, having a series arrangement of components (0, 2, 1, 4) in an axial direction of the component arrangement, a stop spring element of a centrifugal pendulum device of the component arrangement being mounted in the axial direction of the component arrangement by at least one component other than the centrifugal pendulum device.

### BACKGROUND

The present invention relates to a centrifugal pendulum stop spring element for a centrifugal pendulum device, particularly a trapezoidal centrifugal pendulum device of a drive train of a motor vehicle. Further, the invention relates to a centrifugal pendulum device, in particular a trapezoidal centrifugal pendulum device, for a torque transmission device and/or a damper device. Furthermore, the invention relates to a component arrangement for a drive train of a motor vehicle and a torque transmission device or a damper device.

In shafts of periodically operating machines, e.g., at a crankshaft of an internal combustion engine of a motor vehicle, oscillations develop during a rotary motion of the shaft, with their frequency changing with the speed of the shaft. Internal combustion processes of the internal combustion engine trigger oscillations in the drive train of the motor vehicle, particularly during traction mode. In order to reduce these oscillations, a centrifugal pendulum may be provided, which can compensate the oscillations over a wide range of speeds of the internal combustion engine, ideally over the entire range of speeds.

A centrifugal pendulum is based on the principle that, based on the centrifugal force, its pendulum weights tend to circle about the axis of rotation at a distance as large as possible when a rotary motion is introduced. The oscillations in the shaft lead to a vibrating relative motion of the pendulum weights, with the centrifugal pendulum exhibiting a resonance frequency proportional to the speed, so that oscillations with frequencies equivalently proportional to the speed of the shaft can be compensated over a wide range of speeds.

A centrifugal pendulum comprises a multitude of pendulum weights, which are suspended via guide elements at a rotational pendulum weight carrier and can perform a relative motion along a predetermined guide path in reference to the pendulum weight carrier, in order to allow the assumption of a variable distance from the axis of rotation of the pendulum weight carrier. Due to the oscillations in the drive train the pendulum weights are excited to swing and/or oscillate, with their focal points permanently changing, temporarily off-set in reference to the oscillations in the drive train, which leads to a damping of the oscillations caused by a mechanical feedback. An efficient damping can occur by an appropriate adjustment of the pendulum weights and their guide paths.

In order to prevent that in case of maximum oscillation angles the pendulum weights and/or their guide elements excessively impinge each other and/or in/at the pendulum carrier, here rubber elements are provided as stop elements at the appropriate positions of the centrifugal pendulum. Such rubber elements exhibit a number of disadvantages. For example, they are hard to calculate under the aspects of thermal expansion, deformation under the impact of force, and with regards to their tolerances. The reliability and service life of rubber elements is problematic, particularly in an oily environment. Further, rubber elements rapidly lose their elastic features at low temperatures.

### SUMMARY

The objective of the invention is to provide an improved stop element of a centrifugal pendulum device. Further, an object of the invention is to provide an improved centrifugal pendulum device, an improved component arrangement, an improved torque transmission device, and/or an improved damper device, particularly for a drive train of a motor vehicle. Here, it shall be comparatively easy to calculate the stop element according to the invention and it shall be permanently reliable and fulfill its function at least satisfactorily under all conditions of use.

The objective of the invention is attained by a centrifugal pendulum stop spring element for a centrifugal pendulum device of a drive train of a motor vehicle; by a centrifugal pendulum device, particularly a trapezoidal centrifugal pendulum device, for a torque transmission device and/or a damper device; by a component arrangement for a drive train of a motor vehicle; and by a torque transmission device or a damper device, particularly for the drive train of a motor vehicle. Advantageous further developments, additional features, and/or advantages of the invention are discernible from the following description.

The centrifugal pendulum device stop spring element according to the invention, hereinafter called stop spring element, comprises a multitude of material layers in a radial direction of the stop spring element, with the material layers being coupled to each other such that the stop spring element is embodied elastically in its radial direction. In an idle position of the stop spring element the material layers of the stop spring element may be spaced apart from each other in the radial direction. Here, the stop spring element may be embodied as a spiral leaf spring, with the spiral leaf spring preferably being embodied as one piece, particularly in an integral fashion. Further, in the idle position of the stop spring element the material layers of the stop spring element may be closely adjacent to each other in the radial direction. Here, the stop spring element may be embodied as a sheath spring system, with the sheath spring system preferably comprising several parts, particularly several parts in a closed fashion.

In exemplary embodiments of the invention the stop spring element, embodied as a spiral leaf spring, may exhibit an assembly section and/or a rotary stop which preferably extend in a planar fashion and/or tangentially away from the spiral leaf spring. Further, in exemplary embodiments of the invention the stop spring element embodied as a sheath spring system may have a spring slot in at least two material layers. The spring slots of the material layers in the sheath spring system may be embodied such that they are aligned in its radial direction.

According to the invention the stop spring element is preferably embodied as a primarily or essentially tubular stop spring element. The stop spring element may show two, three, four, five, six, seven, or more material layers, independent of the respective material or with the material abutting each other. Further, the stop spring element embodied as a sheath spring system may comprise two, three, four, five, six, or more coaxial, preferably slotted individual sheaths. Furthermore, the stop spring element embodied as a sheath spring system may have a spring slot in all its material layers.

The centrifugal pendulum device comprises a pendulum weight carrier and/or a pendulum weight, with the centrifugal pendulum device according to the invention having a stop spring element according to the invention. Here, the stop spring element is provided on/in the pendulum weight carrier such that preferably an inner stop of the pendulum weight can abut the stop spring element of the pendulum weight carrier in the radial direction of the centrifugal pendulum device. Further, the stop spring element may be provided on/in the pendulum weight such that the stop spring element can preferably contact an inner stop of the pendulum weight carrier in the radial direction of the centrifugal pendulum device.

In some embodiments of the invention the stop spring element can be mechanically pre-stressed in its radial direction on/in the pendulum weight carrier and/or the pendulum weight. The inner stop of the pendulum weight carrier and/or the pendulum weight can be embodied as a bearing seat or a brim. Further the stop spring element can be implemented on/in the centrifugal pendulum device such that the respective stop contacts the stop spring element in an essentially maximum deflection of a pendulum weight. Furthermore, the stop spring element can be fastened in its circumferential direction essentially entirely on/in the centrifugal pendulum device. Furthermore, the stop spring element can be supported in an axial direction via the centrifugal pendulum device itself, not at all, only unilaterally, or at two sides.

The component arrangement according to the invention comprises a serial arrangement of components in an axial direction of the component arrangement, with a stop spring element of a centrifugal pendulum device of the component arrangement being supported and/or fastened in at least one axial direction of the component arrangement by at least one component different from the centrifugal pendulum device. Here, the stop spring element may represent a stop spring element according to the invention and/or the centrifugal pendulum element may be a centrifugal pendulum device according to the invention.

In embodiments according to the invention both components respectively different from the centrifugal pendulum device may support and/or fasten the stop spring element in both axial directions. Here, one component may represent a hub and/or the other component a damping device or a damper. The stop spring element may here be supported and/or fastened at a projection or collar of the component, preferably the hub, in an axial direction. Further, here the stop spring element may be supported and/or fastened in one axial direction at a brace, projection, or tab of the component, preferably the damper device. Furthermore, the centrifugal pendulum device may be fastened at the component and/or vice versa.

The torque transmission device according to the invention or the damper device according to the invention, e.g., a centrifugal pendulum, a torque moment converter, a clutch, a fluid coupling, a clutch assembly, a damper, a damper device, a damper assembly, a turbine damper, a pump damper, an oscillation damper, at two-weight converter, a two-weight flywheel, a component arrangement, etc. or a combination thereof, has a stop spring element according to the invention, a centrifugal pendulum device according to the invention, and/or a component arrangement according to the invention.

The stop spring element according to the invention can rather easily be calculated compared to rubber elements and here reliably fulfill its functions under all conditions of use. Furthermore it is advantageous that the stop spring element according to the invention is mechanically stressed in its entirety, considerably improving the material utilization in reference to rubber elements. Further, in case of a mechanical impact by the stop spring element the embodiments of the invention are not stressed by rivet connections, particularly rivet connections of weight halves of pendulum weights. Furthermore, a tolerance calculation is not referred to spring tolerances, but positively to tolerances of spring seat areas.

### BRIEF DESCRIPTION OF THE DRAWINGS

In the following the invention is explained in greater detail based on exemplary embodiments with reference to the attached drawing. Elements or components showing an identical, univocal, or analogous embodiment and/or function are marked with the same reference character in different figures (Fig.) of the drawing. In the detailed figures of the drawing it shows:

FIG. 1 in a perspective view, an exemplary embodiment of a first variant of the stop spring element according to the invention for a centrifugal pendulum device;

FIG. 2 also in a perspective view, an embodiment of the first variant of the stop spring element;

FIG. 3 again in a perspective view, an embodiment of a second variant of the stop spring element according to the invention for a centrifugal pendulum device;

FIG. 4 in a two-dimensional side view, a stop spring element assembled in a centrifugal pendulum device according to a first variant of the invention;

FIG. 5 in a transparent two-dimensional side view, an embodiment of a centrifugal pendulum device according to the invention, shown with stop spring elements according to the invention provided inside on/in the pendulum weight device, according to the first variant and an essentially maximal oscillation angle of the pendulum weights;

FIG. 6 in a perspective view, an embodiment of a pendulum weight according to the invention comprising a stop spring element according to the invention between two weight halves;

FIG. 7 in a partially removed, two-dimensional circumferential cross-section a centrifugal pendulum device with a stop spring element according to the invention between two disks constituting the pendulum weight carrier of the centrifugal pendulum device;

FIG. 8 in a perspective view, a pendulum weight carrier according to the invention of a centrifugal pendulum device, showing an internal stop for a stop spring element according to the invention of a pendulum weight;

FIG. 9 in a two-dimensional circumferential cross-section, a fastening element between two pendulum weights, on which a stop spring element according to the invention is supported, with the circumferential edges of the pendulum weight halves not being shown;

FIG. 10 in a perspective view, a component arrangement according to the invention of a drive train of a motor vehicle, comprising a hub, a centrifugal pendulum device according to the invention, and a damper device; and

FIG. 11 a detail of FIG. 10, with a stop spring element according to the invention being supported in its two axial directions by the hub and the damper device on/in the centrifugal pendulum device.

### DETAILED DESCRIPTION OF THE PREFERRED EMBODIMENTS

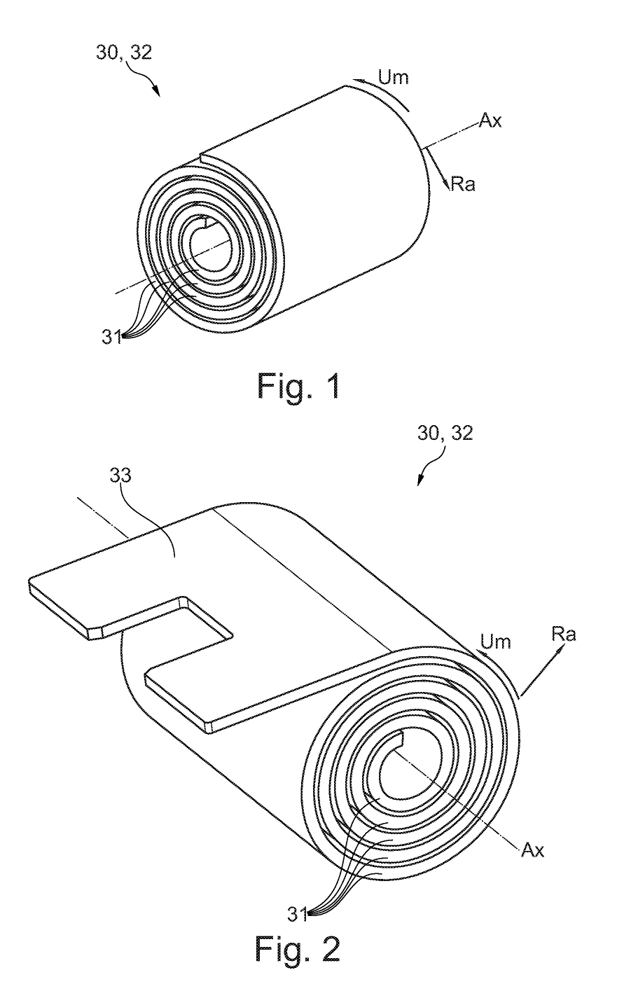

The invention explained in the following essentially relates to a stop spring element 30 (see FIGS. 1 to 3) for a centrifugal pendulum device 1 and/or a centrifugal pendulum 1 (see below), with the stop spring element 30 being assembled from a multitude of material layers 31. The material layers 31 are here arranged in the radial direction Ra of the stop spring element 30 and provide the stop spring element 30 with an essentially tubular shape. The individual material layers 31 preferably comprise an elastic material, particularly spring steel, and constitute the stop spring element 30 such that it is embodied elastically at least in the radial direction Ra. Further, the stop spring element 30 can also be embodied elastically in a circumferential direction Um of the stop spring element 30. Of course, the invention is not limited to the variants and embodiments shown.

FIGS. 1 and 2 each show a stop spring element 30 of a first variant of the invention embodied as a spiral leaf spring 32. Here, the spiral leaf spring 32 exhibits a multitude of material layers 31, all of which embodied from a single material or integrally connected to each other. In the present case, five material layers 31 are provided, but a number of material layers 31 deviating therefrom can also be used, of course (cf. FIG. 9). A cross-section of the radial direction Ra of the spiral leaf spring 32 is here embodied spirally, with the spiral leaf spring 32 being rolled from an essentially rectangular and comparatively long (see below) spring steel to form the spiral leaf spring 32.

Here, a gap (see below) is provided between the respective material layers 31 in the radial direction Ra of the spiral leaf spring 32, which provides the spiral leaf spring 32 with elastic features in the radial direction Ra. The spiral leaf spring 32 can be provided at the outside with an assembly section 33 and/or a torque-proofing device 33 (FIG. 2), preferably made in one piece from a single material or integrated, by which the spiral leaf spring 32 can be fastened in a torque-proof fashion (see below). Here, the assembly section 33 or the torque proofing device 33 represents preferably a planar (tangential) section 33 of the exterior material layer 31, perhaps with a hook at the free end section (see dot-dash section in FIG. 4) for the further fixation of the assembly section 33 and/or the torque-proofing device 33.

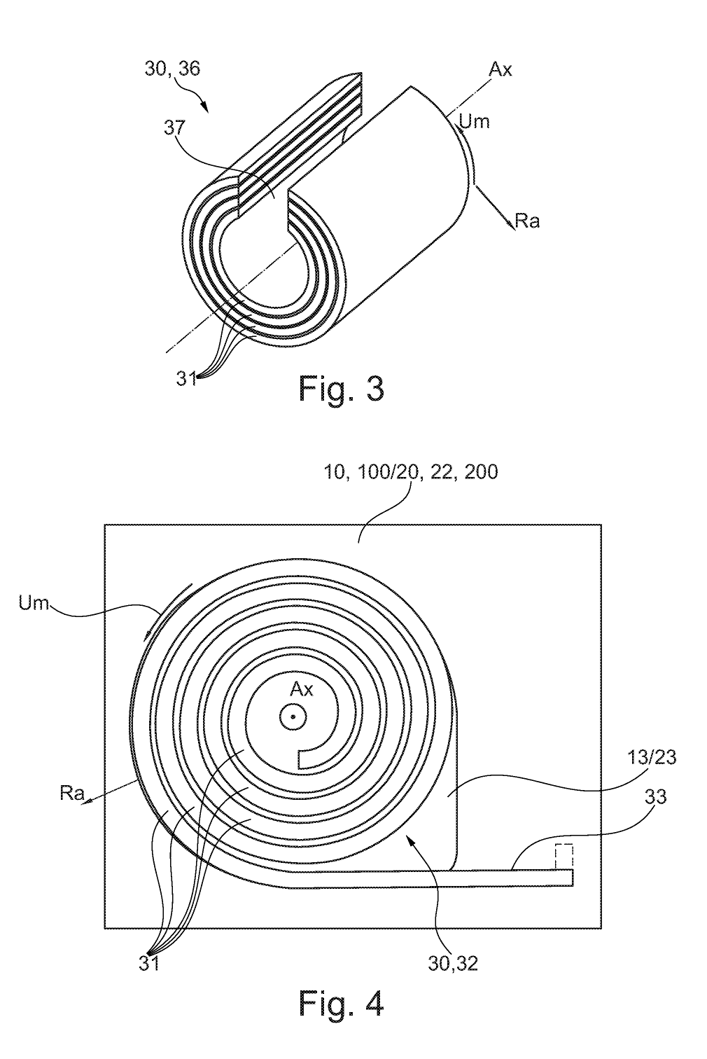

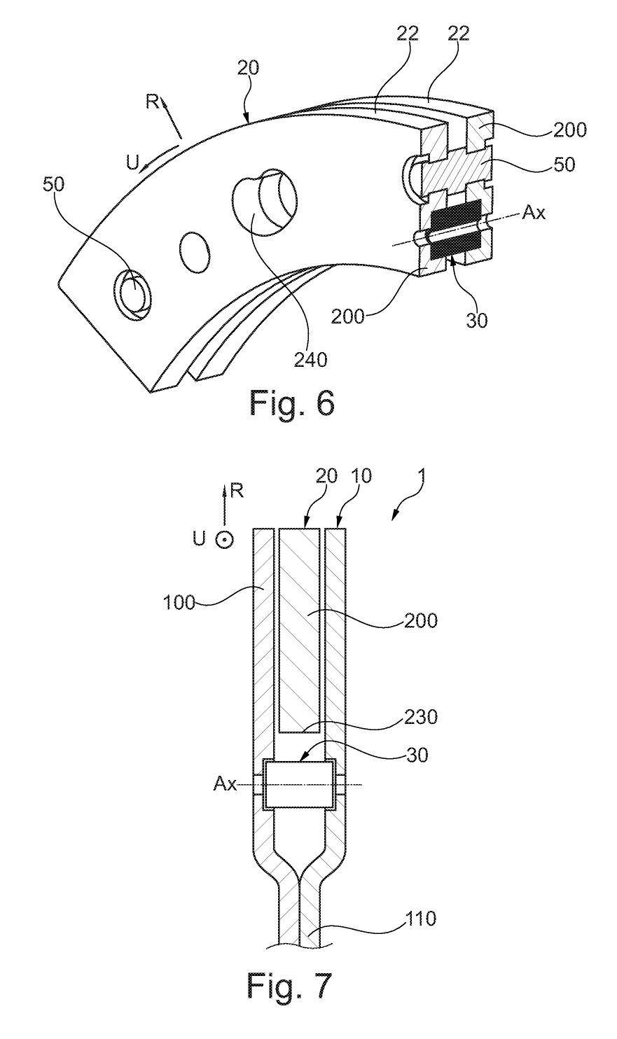

FIG. 3 shows a stop spring element 30 embodied as a sheath spring system 36 of a second variant of the invention. The sheath spring system 36 comprises here a multitude of material layers 31, which are positioned separated from each other in the sheath spring system 36 in an essentially coaxial fashion. In the present case, four material layers 31 are provided, but of course a number of material layers 31 deviating therefrom is possible as well (cf. FIGS. 6, 9).

The individual material layers 31 of the sheath spring system 36 are here positioned relatively closely to each other with their respectively large-area sides (see above) so that the laminate of the individual sheaths (material layers 31) features a certain stability in the axial direction Ax of the sheath spring system 36. Further, at the sheath spring system 36, preferably at the external sheath 31, an assembly section 33 and/or a torque-proofing device 33 can be applied according to the first variant of the invention.

A cross-section in the radial direction Ra of the sheath spring system 36 is here essentially formed by the interrupted circular rings, with an individual material layer 31 of the sheath spring system 36 being rolled from an essentially rectangular and comparatively short (see above) spring sheet. The further outside the casing layer 31 is implemented as the sheath 31 in the sheath spring system 36 the longer this constituting spring sheet needs to be. Here, preferably each sheath-like material layer 31 is provided in an axial direction Ax of the sheath spring system 36 with a penetrating slot 37 embodied as a spring slot 37 in the axial direction Ax, providing the spring sheath system 36 with the elastic features in its radial direction Ra. Preferably the spring slots 37 of the material layers 31 are aligned to each other in an individual sheath spring system 36.

FIG. 4 shows an assembly environment of a stop spring element 30 embodied as a spiral leaf spring 32; the statement thereto are transferable to a sheath spring system 36. Preferably the stop spring element 30 is pre-stressed in the radial direction Ra, provided in a recess 13, 23 of a pendulum weight carrier 10 and/or a pendulum weight 20 of the centrifugal pendulum device 1 (see below). The respective recess 13, 23 is here embodied such that the stop spring element 30 can be accepted in the recess 13, 23 at least partially in the circumferential direction Um in a form-fitting fashion. When an embodiment according to FIG. 2 is used, the recess 13, 23 may show a slot in which the assembly section 33 and/or the torque-proofing device 33 can be accepted.

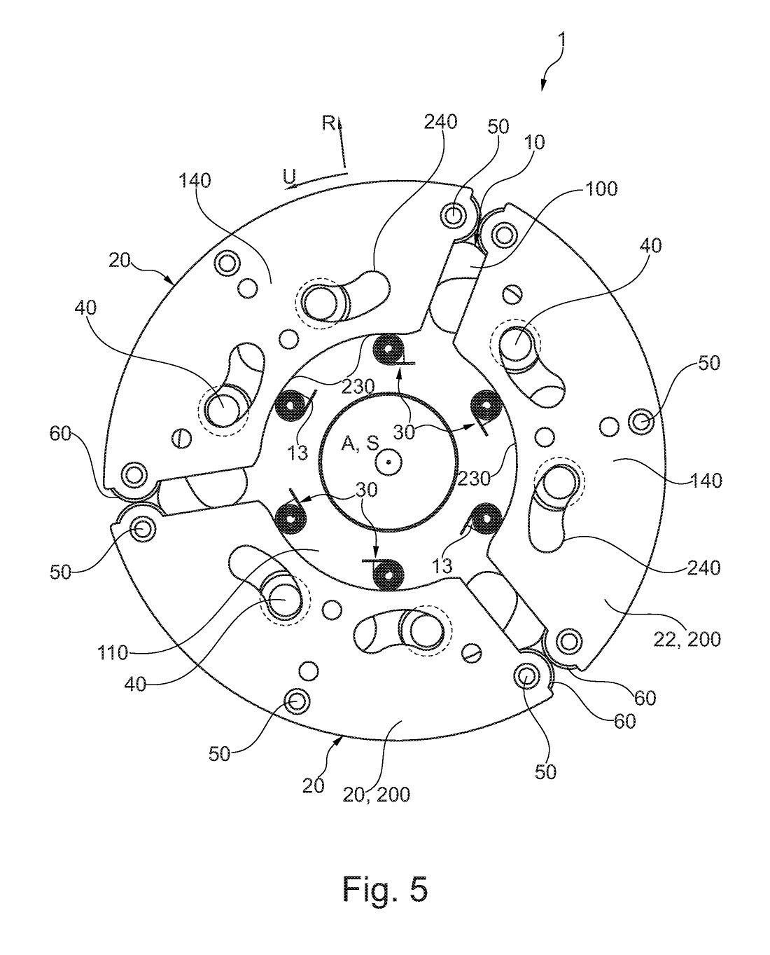

FIG. 5 shows a centrifugal pendulum device 1 according to the invention. It shows stop spring elements 30 according to the invention as shown in FIG. 2 in its radial direction R at the inside on/in its pendulum weight carrier 10. Here, of course stop spring elements 30 according to FIG. 1 or 3 or differently embodied stop spring elements 30 according to the invention may be used as well (this applies to all embodiments of the invention). The pendulum weight carrier 10 has a multitude of stop spring elements 30, arranged at an internal radial perimeter, preferably on a circular path. Here, the stop spring elements 30 project in the axial direction A of the centrifugal pendulum device 1 from the pendulum weight carrier 10 at the side at which the pendulum weight 22 and/or a mass half 22 of the pendulum weight 20 is located.

The stop spring elements 30 are arranged such that a stop 230 of a pendulum weight 20 can rest on a stop spring element 30 when the pendulum weights 20 have reached an essentially maximal angle of deflection, as shown in FIG. 5, and here damp an oscillating motion of the pendulum weight 20. A stop 230 of a pendulum weight 20 is here preferably a radially (R) internal stop 230, extending in the axial direction A and the circumferential direction U, e.g., a bearing seat 230 or a perimeter 230 of the pendulum weight 20. In other angles of deflection of the pendulum weight 20 the pendulum weights 20 rest with their stops 230 not at the stop spring element 30 (not shown). The axial direction A of the centrifugal pendulum device 1 is also its axis of rotation 8.

FIG. 6 shows a pendulum weight 20 according to the invention with two weight halves 22, arranged axially behind each other, which are fixed to each other via at least one fastening means 50, preferably a rivet 50. Preferably two fastening means 50 are provided, which fix the weight halves 22 at the circumferential longitudinal end sections of the weight halves 22, facing away from each other, with a distance therebetween. Here, the fastening means 50 may also be provided at a radially (R) exterior perimeter between the weight halves 22. A radially (R) central provision of one or the fastening means 50 is also possible. According to the invention a stop spring element 30 according to the invention may be provided between the two weight halves 22, which is provided on/in the pendulum weight 20 such that it can rest at an essentially maximum angle of deflection of the pendulum weight 20 at a stop of the centrifugal pendulum device 1. The stop spring element 30 can here in turn represent a spiral leaf spring 32, a sheath spring system 36, etc.

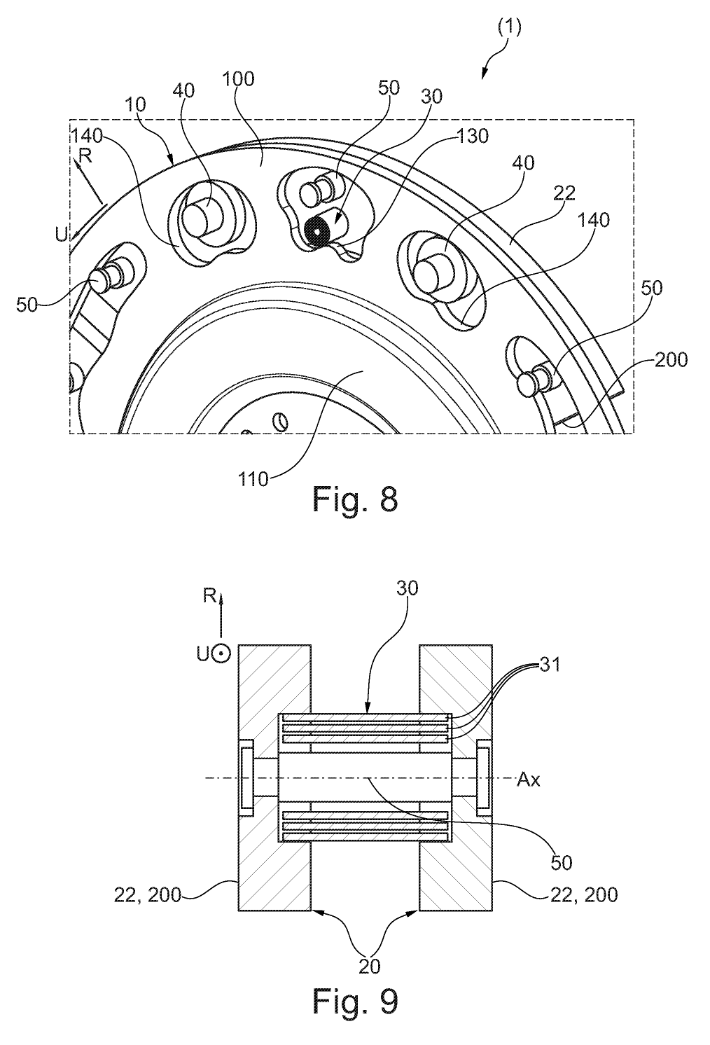

FIG. 8 shows such a stop 130 as an example. It extends preferably in the circumferential direction U and in the axial direction A radially (R) inwardly on/in a punched recess 132 in the pendulum weight carrier 10 for a stop spring element 30 and perhaps a fastening means 50. Here, the stop 130 is an internal stop 130 of the punched recess 132 and may be embodied as a bearing seat 130 or a perimeter 130 of the pendulum weight carrier 10. In an essentially maximum angle of deflection the stop spring element 30 of the pendulum weight 20 may rest at the stop 130 of the pendulum weight carrier 10. The stop spring element 30 is provided here preferably on a line with the axis of rotation S and a fastening means 50 of the pendulum weight 20.

FIG. 7 shows a construction of a centrifugal pendulum device 1 with a two-part pendulum weight carrier 10, with an individual pendulum weight 20 being suspended oscillating between the two parts of the pendulum weight carrier 1. Here, the stop spring element 30 according to the invention may also be suspended between the two parts of the pendulum weight carrier 1, with again a position being selected such that the stop 230 of the pendulum weight 20 rests essentially at the stop spring element 30 at a maximum angle of deflection of the pendulum weight 20. Here, the pendulum weight 20 is radially (R) above, i.e. outside the stop spring element 30.

FIG. 9 shows as an example a stop spring element 30 according to the invention on a fastening means 50, particularly a rivet connection 50. For example the stop spring element 30 rests on the fastening means 50, which fixes two weight halves 22 of a pendulum weight 22, e.g., at the center. Here, similar to all other embodiments, the stop spring element 30 may he embodied as a spiral leaf spring 32, a sheath spring system 36, or another stop spring element 30 according to the invention. Similar to the embodiment of FIG. 9, the innermost sheath 31 of a sheath spring system 36 or also the innermost of a spiral leaf spring 32 may be embodied as a closed sheath or as a massive pin in the circumferential direction Um.

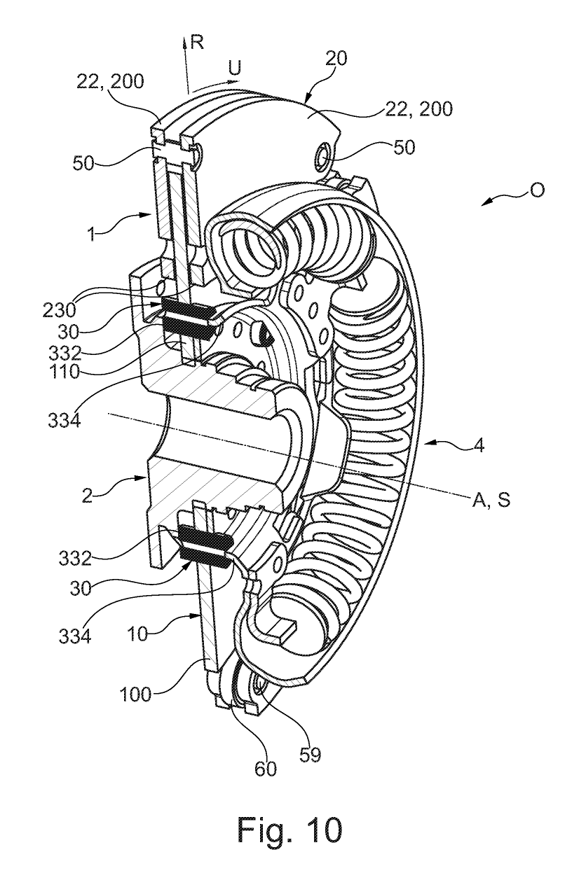

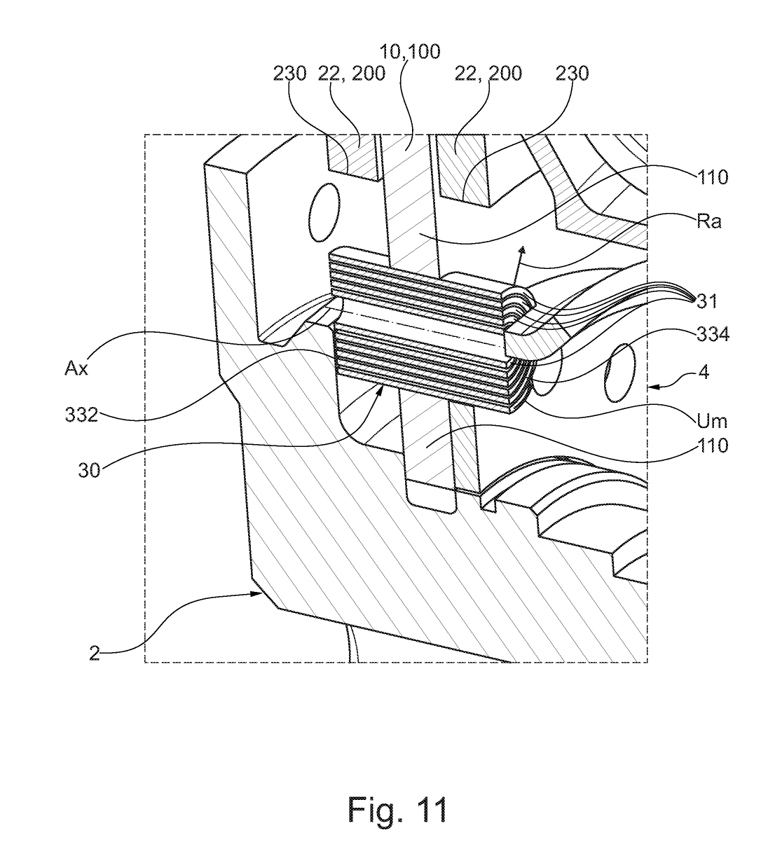

In the axial direction A, FIGS. 10 and 11 show a serial arrangement of components 0; 2, 1, 4, a so-called component arrangement 0; 2, 1, 4 according to the invention for a drive train of a motor vehicle. The component 1 is preferably a centrifugal pendulum device 1 according to the invention, the components 2, 4 may represent arbitrary components 2, 4 (see above, see list of reference characters: Pos. 0—torque transmission device) of a drive train of a motor vehicle. In the present case, the component 2 represents a hub 2 e.g., of a clutch, a turbine, a pump etc. and the component 4 represents a damper 4, a damping device 4, a damper assembly 4, etc.

According to the invention the component arrangement 0;2.1.4 may be embodied such that a stop element, particularly a stop spring element 30 according to the invention is fastened and/or supported at least in an axial direction A (thus also in the axial direction Ax of the stop spring element 30) by one of the components 2, 4. In the present case this occurs by both components 2, 4 in both axial directions A. Here, the stop element and/or the stop spring element 30 according to the invention is fastened in its circumferential direction Um and thus also in the radial direction R of the centrifugal pendulum device 1 on/in the centrifugal pendulum device 1, particularly fastened in the circumferential direction Um in a mechanically pre-stressed fashion.

FIG. 11 shows the axial support of the stop element and/or the stop spring element 30 according to the invention in a greater detail. Here, a projection 332 or collar 332 of the component 2 fastens the stop element and/or the stop spring element 30 according to the invention in one axial direction A, and a brace 334, projection 334, or tab 334 of the component 4 fastens the stop element and/or the stop spring element 30 according to the invention in the other axial direction A. Here, the connecting section 110 of the pendulum weight carrier 10 can rest on/on the component 2, particularly the hub 2, rotationally or in a torque-proof fashion.

List of Reference Characters

0 Torque transmission device, component e.g., centrifugal pendulum, torque converter, clutch, fluid coupling, clutch assembly, damper, damper device, damper assembly, turbine damper, pump damper, oscillation damper, two-weight converter, two-weight flywheel, component arrangement, etc. or combination thereof

1 Centrifugal pendulum device, particularly trapezoidal centrifugal pendulum device, device for speed-adaptive compensation of oscillation

2 Component (also component 0), particularly hub e.g., of a clutch, turbine, pump etc.

4 Component (also component 0), particularly damper, damper device, damper assembly

10 Pendulum weight carrier, pendulum flange, perhaps comprising two parts (FIG. 7)

13 Recess for the assembly of the stop spring element 30

20 Pendulum weight, compensation weight, inertia weight e.g., of two weight halves 22 arranged axially (A) behind one another or showing only a single weight (FIG. 7)

22 Weight half, individual weight of the pendulum weight 20

23 Recess for the assembly of the stop spring element 30

30 (centrifugal pendulum) stop spring element, e.g., spiral leaf spring 32, sheath spring system 36, etc.

31 Material layer of the stop spring element 30

32 Stop spring element embodied as a spiral leaf spring

33 Assembly section, torque-proofing device of the spiral leaf spring 32, preferably planar (tangential) section, perhaps with hooks at the free end section

36 Stop spring element embodied as a sheath spring system

37 Spring slot of a material layer 31 of the sheath spring system 36 and/or the sheath spring system 36

40 Guide element for the oscillating support of the pendulum weight 20, particularly a coil cradle, cylinder roll, runner, glide element, rivet, pin, continuous or staged

50 Fastening means for a mutual fastening of two weight halves 22 arranged axially (A) behind each other in reference to the pendulum weight 20, preferably a rivet

60 Conventional spring / damper part

100 Disk-shaped, i.e. planar and relatively thin basic body of the pendulum weight carrier 10

110 Connection section of the pendulum weight carrier 10 at the component 0, 2, particularly damper device 0, torque transmission device 0, hub 2, etc.

130 (Radially (R) internal) stop, bearing seat, perimeter of the pendulum weight carrier 10 for supporting the stop spring element 30 of the pendulum weight 20

132 Punched recess in the pendulum weight carrier 10 for the stop spring element 30 and perhaps fastening means 50

140 Guide path in the pendulum weight carrier 10 for the guide element 40 for the oscillating guidance of the pendulum weight 20, preferably roll recess (e.g., punched out)

200 Disk-shaped, i.e. planar and comparatively thin basic body of the pendulum weight 20 and/or the weight half 22

230 (Radially (R) internal) stop, bearing seat, perimeter of the pendulum weight 20 for supporting the pendulum weight 20 at the stop spring element 30 of the pendulum weight carrier 10

240 A guide path in the pendulum weight 20 for the guide element 40 for the oscillating guidance of this pendulum weight 20, roll recess (e.g., punched out)

332 Projection, collar of the component 2, particularly the hub 2

334 Brace, projection, tab of the component 4, particularly the damper device 4

A Axial direction, longitudinal direction of the component arrangement 0; 2, 1, 4 of the component 0, 1, 2, 4 of the centrifugal pendulum device 1, the pendulum weight carrier 10, the pendulum weight 20, etc.

Ax Axial direction of the stop spring element 30, in the assembled state of the stop spring element 30 on/in the centrifugal pendulum device 1 the axial direction Ax is parallel to the axial direction A

R Radial direction of the component arrangement 0; 2,1,4 of the component 0,1,2,4 of the centrifugal pendulum device 1, the pendulum weight carrier 10, the pendulum weight 20, etc.

Ra Radial direction of the stop spring element 30

S Axis of rotation of the component arrangement 0; 2,1,4 of the component 0,1,2,4 of the centrifugal pendulum device 1, the pendulum weight carrier 10, the pendulum weight 20, etc.

U Circumferential direction of the component arrangement 0; 2,1,4 of the component 0,1,2,4 of the centrifugal pendulum device 1, the pendulum weight carrier 10, the pendulum weight 20, etc.

Um Circumferential direction of the stop spring element 30

1. A centrifugal pendulum stop spring element for a centrifugal pendulum device of a drive train of a motor vehicle, the stop spring element comprises a plurality of material layers in a radial direction (Ra) of the stop spring element, with the material layers being coupled to each other to provide elasticity in a radial direction (Ra).

2. The centrifugal pendulum stop spring element according to claim 1, wherein in an idle position of the stop spring element the material layers of the stop spring element are spaced apart from each other in the radial direction (Ra).

3. The centrifugal pendulum stop spring element according claim 1, wherein in the idle position of the stop spring element the material layers of the stop spring element are closely adjacent to each other in the radial direction (Ra).

4. The centrifugal pendulum stop spring element according to claim 1, wherein the stop spring element is embodied as a spiral leaf spring and has an assembly section or a torque-proofing device, which extends in at least one of a planar or tangential fashion away from the spiral leaf spring.

5. The centrifugal pendulum stop spring element according to claim 1, wherein:
the stop spring element is embodied as a tubular stop spring element; and
the stop spring element comprises two, three, four, five, six, or seven of the material layers of mutually independent materials or materially following each other.

6. A centrifugal pendulum device, comprising a pendulum weight carrier and a pendulum weight, and a centrifugal pendulum stop spring element according to claim 1 connected to at least one of the pendulum weight carrier or the pendulum weight.

7. The centrifugal pendulum device according to claim 6, wherein the stop spring element is provided on or in the pendulum weight carrier such that an inner stop of the pendulum weight rests in a radial direction (R) of the centrifugal pendulum device at the stop spring element of the pendulum weight carrier.

8. The centrifugal pendulum device according to claim 6 wherein:
the stop spring element is provided mechanically pre-stressed in the radial direction (Ra) thereof on or in the pendulum weight carrier or the pendulum weight;
an inner stop of the pendulum weight carrier or the pendulum weight is embodied as a bearing seat or perimeter;
the stop spring element is embodied on or in the centrifugal pendulum device such that the inner stop in an essentially maximum deflection of a pendulum weight rests on the stop spring element; and
the stop spring element is held essentially completely on or in the centrifugal pendulum device in a circumferential direction (Um).

9. A component arrangement for a drive train of a motor vehicle with a serial arrangement of components in an axial direction (A) of the component arrangement, the component arrangement comprising a centrifugal pendulum device with a stop spring element, the stop spring element of the centrifugal pendulum device of the component arrangement of at least one component not included in the centrifugal pendulum device is supported in the axial direction (A, Ax) of the component arrangement.

10. The component arrangement according to claim 9, wherein:
the stop spring element comprises a plurality of material layers in a radial direction (Ra) of the stop spring element, with the material layers being coupled to each other;
the centrifugal pendulum device comprises a pendulum weight carrier and a pendulum weight, and the stop spring element is connected to at least one of the pendulum weight carrier of the pendulum weight;
two each of the components, not included in the centrifugal pendulum device, support the stop spring element in both axial directions (A, Ax);
the component represents a hub or the components represent a damper device or a damper;
the stop spring element rests at a projection or collar of the component in an axial direction (A, Ax); or
the stop spring element rests on a brace, a projection, or a tab of the component, in an axial direction (A, Ax); or
the centrifugal pendulum device is fastened to the component.

11. The centrifugal pendulum stop spring element according to claim 1, wherein the stop spring element is embodied as a spiral leaf spring, with the spiral leaf spring being embodied in one piece.

12. The centrifugal pendulum of claim 1, wherein the stop spring element is embodied as a sheath spring system, with the sheath spring system being embodied from several parts.

13. The centrifugal pendulum of claim 1, wherein the stop spring element is embodied as a sheath spring system and has a spring slot in at least two of the material layers, with the spring slots of the material layers being arranged in the sheath spring system such that they are aligned in the radial direction (Ra).

14. The centrifugal pendulum of claim 1, wherein the stop spring element is embodied as a sheath spring system and comprises two, three, four, five, or six coaxial individual sheaths.

15. The centrifugal pendulum of claim 1, wherein the stop spring element is embodied as a sheath spring system and includes a spring slot in all of the material layers.

16. The centrifugal pendulum device according to claim 6, wherein the stop spring element is provided on or in the pendulum weight such that the stop spring element rests at an inner stop of the pendulum weight carrier in a radial direction (R) of the centrifugal pendulum device.

17. The centrifugal pendulum device according to claim 6, wherein the stop spring element is supported in an axial direct (A, Ax) via the centrifugal pendulum device itself, not held, only held at one side or at both sides.
